(19) United States
(12) Patent Application Publication
(10) Pub. No.: US 2017/0337681 A1
(43) Pub. Date: Nov. 23, 2017

(54) System and method for the classification of healthiness index from chest radiographs of a healthy person

(71) Applicant: Shenzhen Smart Imaging Healthcare Co., Ltd., Shenzhen (CN)

(72) Inventors: Yuan-Ming Fleming Lure, Potomac, MD (US); Hao Zhou, Shenzhen (CN)

(21) Appl. No.: 15/530,633

(22) Filed: Feb. 13, 2017

Related U.S. Application Data
(60) Provisional application No. 62/389,758, filed on Mar. 9, 2016.

(51) Int. Cl. G06T 7/00; G06T 7/11; G06K 9/46; G06K 9/62; G06T 7/13

(52) U.S. Cl. CPC G06T 7/0012; G06K 9/628; G06T 7/13; G06K 9/46; G06T 7/11; G06T 2200/28; G06T 2207/10116; G06T 2207/30061

(57) ABSTRACT

A method for classifying the degree of healthiness from chest radiographs comprises inputting image data with a medical imaging acquisition system or from individual's computers or smartphones or cloud storage devices. The image data is transmitted from the medical imaging acquisition system or from the computers or storage device to a computer-aided-analysis (CAA) system via the Internet and an archive/review station. Classification results are generated by processing the image data to perform lung segmentation and generate various radiomics, perform classification of radiomics. The classification results are transmitted from the CAA system to archive/review servers or the computers/smartphones via the Internet. The classification results are used to retrieve the associated clinical, wellness, and health knowledge from the database to form composite data. The composite data is sent to end users including patients, healthcare providers, consultants, and other authorized personnel and displayed by the archive/review system or the computers/smartphones.

### FIELD OF THE INVENTION

The present invention relates to an automated method and system for digital image processing of radiologic images and, more specifically, to an automated method and system for the classification of different healthiness indices, using radiomics, digital image processing and artificial intelligence.

### BACKGROUND OF THE INVENTION

Many companies and government agencies offer annual physical exams to every people, regardless the age, as part of their fringe benefits or prior to their employment. Chest X-ray is sometimes included in the physical exam. Although most of people will be normal on the chest ray, people are very concerning about their potential development of heart and lung diseases especially lung cancer due to high air pollution and would like to prevent or slow down the trend to develop lung cancer. Lately, more and more of people have obtained their digital chest X-ray images to store in their computers, smart phones, or cloud storage devices. Classification of normal X-ray into different healthiness degrees will help people to improve their health.

A chest X-ray is typically acquired to help to (1) find the cause of common symptoms such as a cough, shortness of breath, or chest pain; (2) find lung conditions—such as pneumonia, lung cancer, chronic obstructive pulmonary disease (COPD), collapsed lung (pneumothorax), or cystic fibrosis and monitor treatment for these conditions; (3) find some heart problems, such as an enlarged heart, heart failure, and problems causing fluid in the lungs (pulmonary edema), and to monitor treatment for these conditions; (4) look for problems from a chest injury, such as rib fractures or lung damage; and (5) find foreign objects camera.gif, such as coins or other small pieces of metal, in the tube to the stomach (esophagus), the airway, or the lungs. A chest X-ray may not be able to see food, nuts, or wood fibers. See if a tube, catheter, or other medical device has been placed in the proper position in an airway, the heart, blood vessels of the chest, or the stomach.

Most chest diseases are not acute. Only when symptoms change from early sign to obvious or severe sign, the symptoms become pre-clinical and clinical diseases. The early symptoms in the “normal” chest radiographs are the sign that will be used as healthiness index to determine the degree of healthiness for healthy people. This sign in chest radiographs will be represented quantitatively as the image features known as Radiomics.

Radiologist's experiences in classification of healthy radiographs includes the following categories: This may be like a “b reading” of the normal chest X-ray; cardio-thoracic ratio; age corrected lung volume: COPD (inspiration effort); aortic atrioventricular septal defect (ASVD); apical thickening; osteopenia, wedge defects; and asbestos exposure resulting in pleural plaques that can be associated with a rare cancer mesothelioma.

Above same reasoning to determine healthiness index of healthy population can be applied to other screening images such as breast mammogram, low dose CT screening, pap smear screening images, protein images of DNA, etc.

### SUMMARY OF THE INVENTION

The present disclosure provides a system and method for classification of healthiness indices from chest radiographs of a healthy person.

An embodiment of the present disclosure discloses a method for classifying healthiness indices in a normal radiological image. The method comprises the steps of: image pre-processing comprising image enhancement and normalization processing to enhance image contrast; image segmentation to identify body parts and boundaries thereof, the image segmentation step further comprising a sub-step of differentiation of different zones within a lung region of said radiological image based on anatomic structures of the lung region and on local image characteristics; radiomics extraction to extract radiomics to indicate different image characteristics and features associated with symptoms of potential diseases; and radiomics classification processing based on radiomics to determine the healthiness indices and identify a location of a region of interest.

Another embodiment of the present disclosure discloses a method, to be used in a non-diagnostic medical cloud computing environment, for performing computer-aided-analysis (CAA) capability in said cloud computing environment. The method comprises the steps of transmitting image data from at least one non-diagnostic medical imaging acquisition system or individual computers, smartphones, or storage devices to at least one computer-aided-analysis (CAA) system in the cloud computing environment and at least one archive/review station; generating computer-aided-analysis results by processing said image data to determine radiomics and classify into a plurality of healthiness indices in the image data using said CAA system, while archiving and viewing said image data on at least one of said at least one archive/review station, the computers, the smartphones, printed media, and the storage devices; and transmitting said computer-aided-analysis results from said CAA system via an Internet by cloud computing to at least one of said at least one archive/review station, the computers, the smartphones, the printed media, and the storage devices. The transmitting image data step and said transmitting said computer-aided-analysis results step are performed in a digital imaging and communications in medicine (DICOM) image formats and over the Internet connected among said at least one non-diagnostic medical imaging acquisition system, said CAA system, and said at least one archive/review station, the computers, the smartphones, the printed media, or the storage devices.

### BRIEF DESCRIPTION OF THE DRAWINGS

For a greater understanding of the present invention and of the advantages thereof, reference is now made to the following description taken in conjunction with the accompanying drawings, in which:

FIG. 1 illustrates a schematic block diagram of a medical non-diagnostic or diagnostic workflow environment incorporating a computer-aided-analysis (CAA) system between users and internee cloud.

FIG. 2 illustrates a schematic block diagram of a medical non-diagnostic or diagnostic environment incorporating a computer-aided-analysis (CAA) system between a non-diagnostic or diagnostic medical imaging acquisition system, individual computer system, smartphone, storage device, media and an archive/review station.

FIG. 3 is a description of server farm and database server in the non-diagnostic or diagnostic medical environment of FIG. 2 in accordance with an embodiment of the present invention.

FIG. 4 illustrates a system for implementing the Healthiness Index Generation Server method of the present invention of FIG. 3.

FIG. 5 is a schematic diagram of a processing unit method according to an embodiment of the present invention embodied in FIG. 4.

FIG. 6 is a schematic diagram of a lung segmentation unit according to an embodiment of the present invention.

FIG. 7 is a schematic diagram of a radiomics extraction unit according to an embodiment of the present invention.

FIG. 8 is a schematic diagram of a radiomics extraction from a lung boundary processing unit according to an embodiment of the present invention.

FIG. 9 is a schematic diagram of a radiomics extraction from an area-based processing unit according to an embodiment of the present invention.

FIG. 10 is a schematic diagram of a radiomics extraction from a focal point, symmetry, and lateral view processing unit according to an embodiment of the present invention.

FIG. 11 is a schematic diagram of a classification of radiomics unit according to an embodiment of the present invention.

FIG. 12 is a schematic diagram of a radiomics classification by the lung boundary processing unit according to an embodiment of the present invention.

FIG. 13 is a schematic diagram of a radiomics classification by the area-based processing unit according to an embodiment of the present invention.

FIG. 14 is a schematic diagram of a radiomics classification by the focal point processing unit according to an embodiment of the present invention.

FIG. 15 is a schematic diagram of a radiomics classification by a symmetry-based processing unit according to an embodiment of the present invention.

FIG. 16 is a schematic diagram of a radiomics classification by the lateral-view processing unit according to an embodiment of the present invention.

FIG. 17 shows an example of an output from the present invention.

### DETAILED DESCRIPTION OF THE PREFERRED EMBODIMENTS

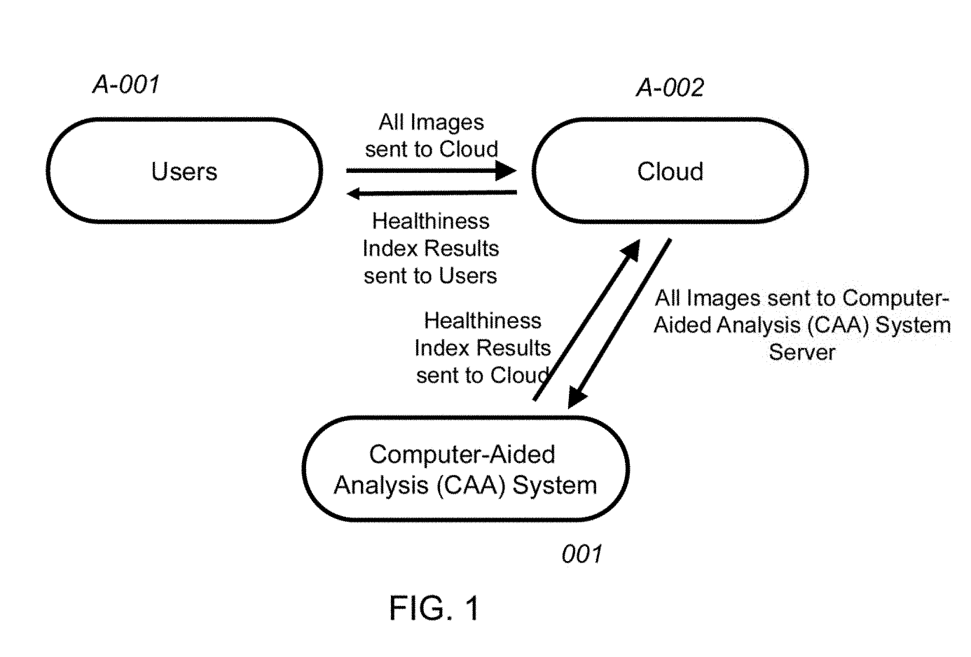

FIG. 1 illustrates a schematic block diagram of a medical non-diagnostic or diagnostic workflow environment incorporating a computer-aided-analysis CAA) system 001 between users A-001 and internet cloud A-002.

The users A-001 sends all images to the cloud from the image acquisition systems, computers, smartphone, media, storage device, to internet cloud A-002. The interne cloud A-002 sends all images to Computer-Aided Analysis (CAA) System Server. The CAA system performs the classification of healthiness index and sends the classification results back to the cloud A-002. The cloud A-002 then sends the healthiness index to the users A-001.

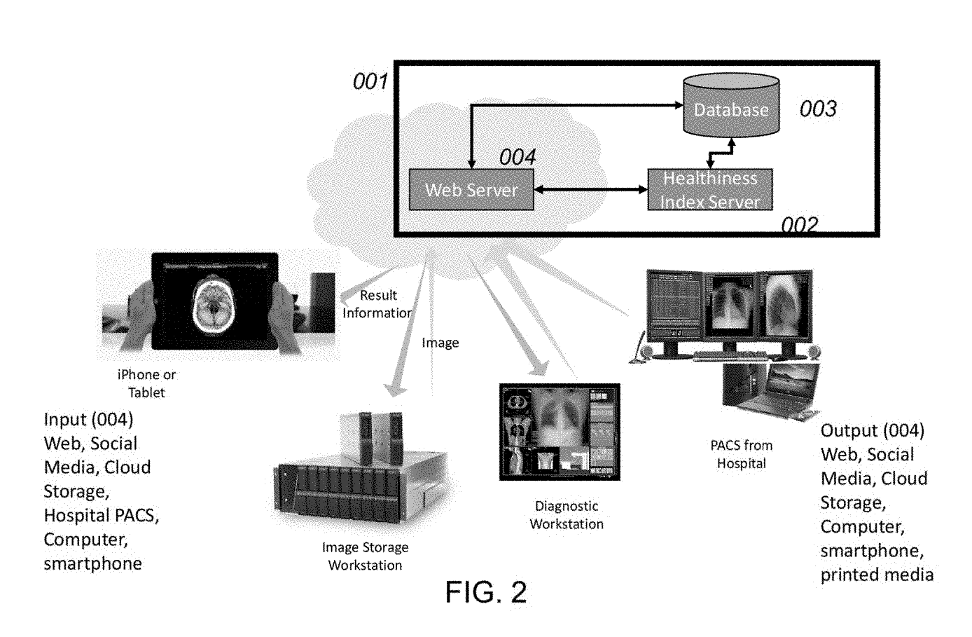

FIG. 2 illustrates a schematic block diagram of a medical non-diagnostic or diagnostic environment incorporating a computer-aided-analysis (CAA) system between a non-diagnostic or diagnostic medical imaging acquisition system, individual computer system, smartphone, storage device, media and an archive/review static.

Input 004 includes Web, Social Media, Cloud Storage, Hospital PACS, computer, smartphone, the like. Output 004 can be Web, Social Media, Cloud Storage, computer, smartphone, printed media, etc. CAA 001 includes web server 004 to allow users to input and receive images and results, respectively, healthiness index server 002 to calculate the healthiness index, and database server 003 to store associated reference and knowledge information to different healthiness index.

Web server farm is located in the cloud and CAA server farm is connected to a CAA database. Users can send the images through iPhone, tablet, image storage server, non-diagnostic workstation, PACS from the hospitals. The web server receives images and applies CAA algorithm to process the images. The CAA results are then sent to CAA database. The CAA database. The web server sends the classification results back to the users.

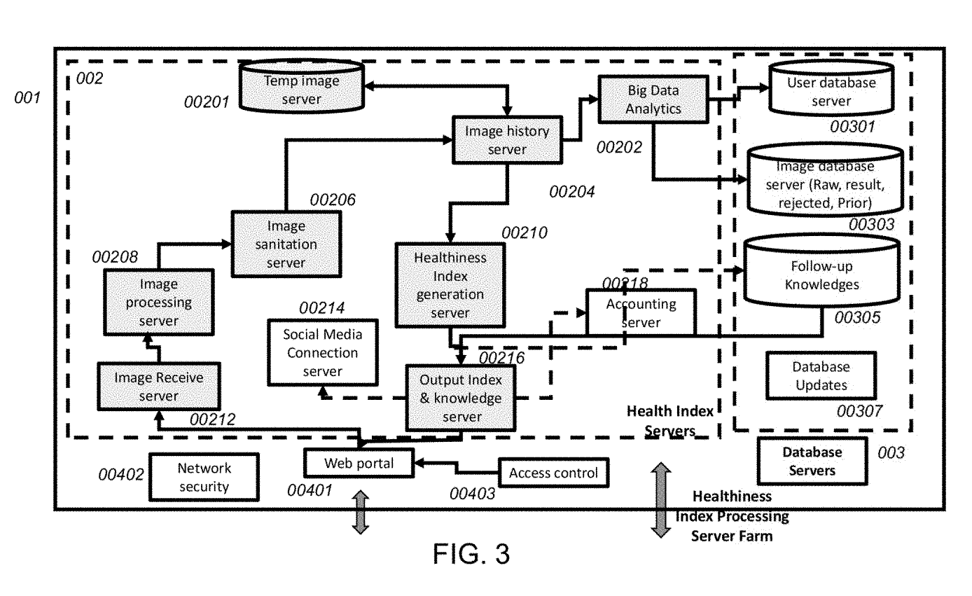

FIG. 3 is a description of server farm in the non-diagnostic or diagnostic medical environment of FIG. 2 in accordance with an embodiment of the present invention. The CAA 001 server farm includes web server 004 to allow users to input and receive images and results, respectively, healthiness index server 002 to calculate the healthiness index, and database server 003 to store associated reference and knowledge information to different healthiness index.

The web server includes web porter 00401, network security 00402, and account control 00403. The web portal 00401 acts as interface between users and all of the servers. The security server 00402 and access control server 00403 maintain the security and access by qualified users, respectively. A network security is implemented to protect the entire server farm. Also, there is access control to allow users, administrators, and vendors to access their own domain or accounts in order to monitor and get the reports.

The healthiness index server 002 includes temp image server 00201, image history server 00204, image sanitation server 00206, image processing server 00208, healthiness index generation server 00210, image receive server 00212, social media connection server 00214, output index and knowledge server 00216, big data analytics 00202, and accounting server 00218. The image is received by the image receive server 00212 to maintain the proper sequence and record for the follow-up processing. The image receive server 00212 send image to image processing server 00208 for simple image processing which can also include some of processing listed in healthiness index generation server 00210. The image sanitation server 00206 examines the header of the image (e.g., digital imaging and communications in medicine (DICOM) header) to determine the proper dimension, bit depth, body part, etc. and to accept this particular image or not. The image history server 00204 records the history of the image and determines any previous determined healthiness index. It also controls the capacity of the processing and moves some of images to the temp image server 00201 to hold the image temporarily. The big data analytics server 00202 also analyzes all the data such as time, location, names, history, etc. to determine certain characteristics for the overall population. The healthiness index generation server 00210 processes each image to determine the healthiness index. Its output is sent to the database server 003 to retrieve the corresponding knowledge and references. The output index result server 00216 sends the index and corresponding knowledge and references to the web server to be sent out to the users. An accounting server 00218 is linked to count the number of images, users, and analysis results have been processed. A social media connection server 00214 is used to notify the users the status of their results. The messenger server can either send the e-mail, text, or other social network mechanism such as Facebook, WeChat, QQ, etc.

The database server 003 consists of user data server 00301 to store users' information for future matching, image database server 00303 for the raw image, result, rejected cases, and prior data, and follow-up knowledge database 00305 that contains the knowledge to maintain the wellness and healthiness for the general public. The database server 003 also consists of database updates 00307 tools to allow users, operators, etc. to update the knowledge and references.

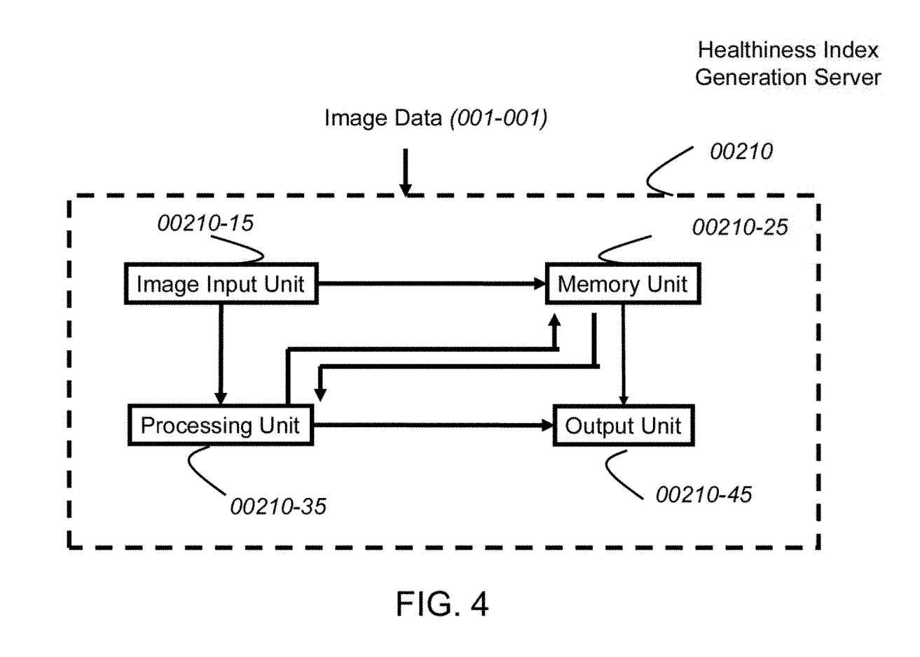

FIG. 4 illustrates a system for implementing the Healthiness Index Generation Server 00210 method of the present invention of FIG. 3;

Healthiness index generation server 00210 receives image in image input unit 00210-15, then sends the images to processing unit 00210-35 and memory unit 00210-25. The processing unit 00210-35 also receives image from previously stored images in memory unit 00210-25. The processing unit generates the healthiness index and sends the index to memory unit 00210-25 and to output unit 00210-45. The output unit 00210-45 also receives image from memory unit 00210-25.

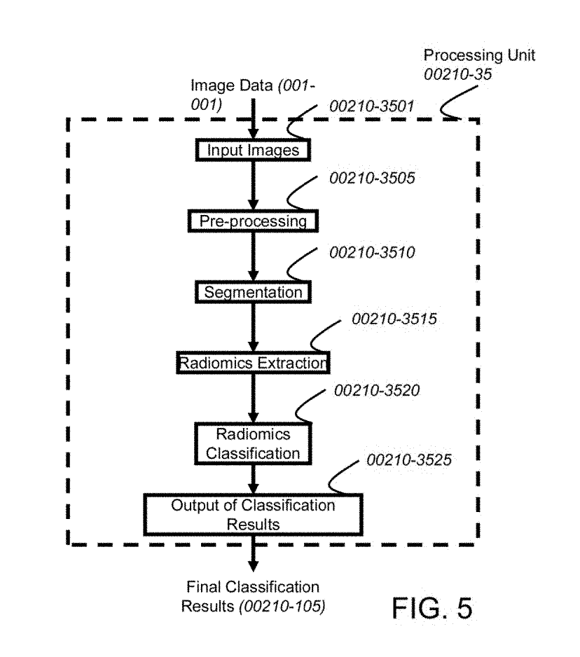

FIG. 5 is a schematic diagram of a processing unit 00210-35 method according to an embodiment of the present invention embodied in FIG. 4;

The processing unit 00210-35 consists of input images processing 00210-3501 to receive the image; preprocessing processing 00210-3505 to perform image enhancement, noise reduction, and filtering; segmentation 00210-3510 to delineate the lung segment, its boundary, and sub-zones; and radiomics extraction 00210-3515 to extract several clinical features, denoted as radiomics; radiomics classification 00210-3520 to classify each image into different healthiness index based on the radiomics; and output of classification results 00210-3525 to indicate the level of healthiness of that particular image.

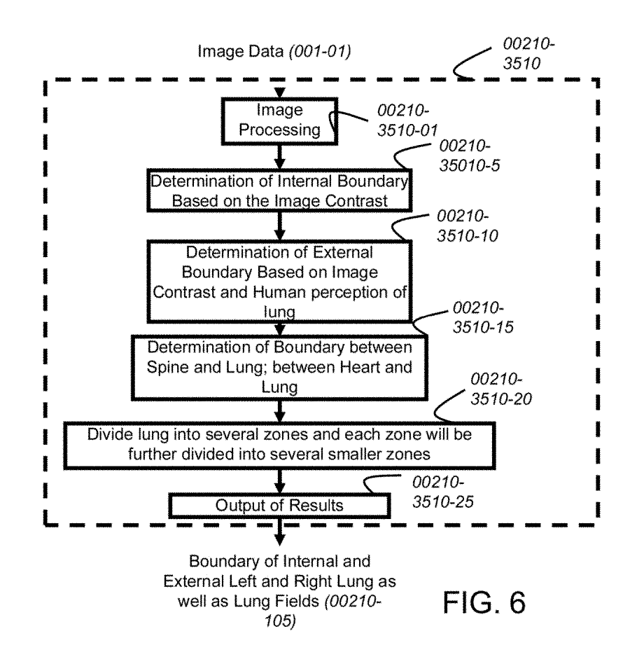

FIG. 6 is a schematic diagram of a lung segmentation unit 00210-3510 according to an embodiment of the present invention;

The lung segmentation unit 00210-3510 consists of image processing 00210-3510-01 to conduct edge detection, thresholding, and other image processing methods; determination of internal boundary based on the image contrast 00210-3510-5 for the inner boundary of entire lungs; determination of external boundary based on image contrast and human perception of lung 00210-3510-10 for the outer boundary of left and right lungs; determination of boundary between spine and lung, and between heart and lung 00210-3510-15 for the boundary of hilum and diaphragm; divide lung into several zones and each zone will be further divided into several zones 00210-3510-20; and output results 00210-3510-25 to generate boundary of internal and external left and right lungs as well as lung fields 00210-105.

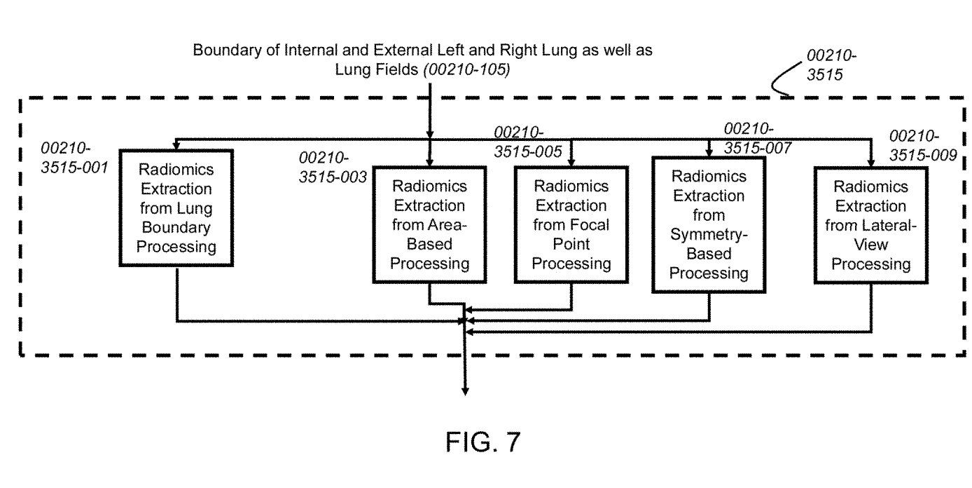

FIG. 7 is a schematic diagram of a radiomics extraction unit 00210-3515 according to an embodiment of the present invention;

The radiomics extraction 00210-3515 receives boundary of internal and external left and right lungs as well as lung fields 00210-105 as well as the segmented lung to conduct several extractions: (1) radiomics extraction from lung boundary processing 00210-3515-001; (2) radiomics extraction from area-based processing 00210-3515-003; (3) radiomics extraction from focal point processing 00210-3515-05; (4) radiomics extraction from symmetry-based processing 00210-3515-007; and (5) radiomics extraction from lateral-view processing 00210-3515-009;

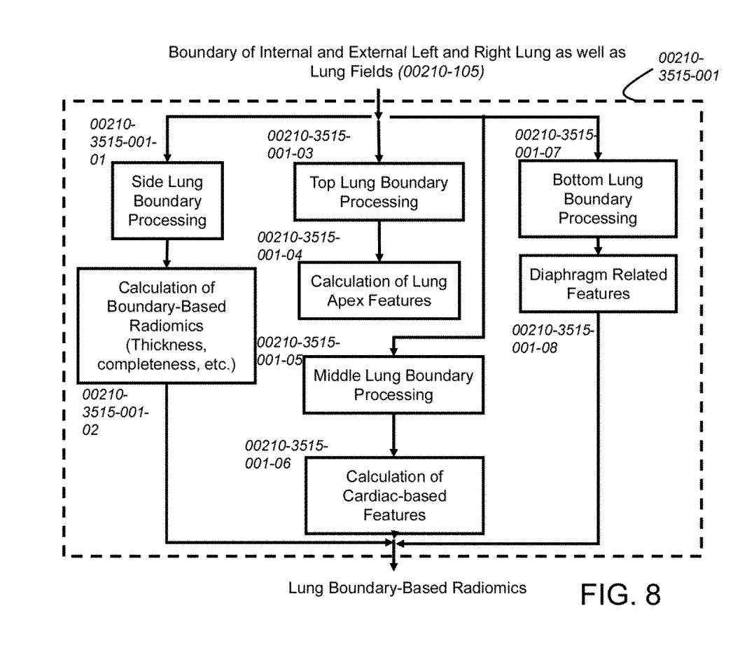

FIG. 8 is a schematic diagram of a radiomics extraction from lung boundary processing unit 00210-3515-001 according to an embodiment of the present invention;

After receiving boundary of internal and external left and right lung as well as lung fields 00210-105, radiomics extraction from lung boundary processing unit 00210-3515-001 consists of (1) side lung boundary processing 00210-3515-001-01 to perform processing including width, smooth, wide, specific for the side of lung boundary; and (2) follow up with calculation of boundary-based radiomics 00210-3515-001-02 such as thickness of boundary, completeness of lung boundary, etc.; (3) top lung boundary processing 00210-3515-001-03 to obtain the profile and thickness of the top lung; and (4) follow up with calculation of lung apex features 00210-3515-001-04 to obtain the shape, profile, thickness, and completeness; (5) middle lung boundary processing 00210-3515-001-05 to obtain the profile and thickness of the middle lung; and (6) follow up with calculation of cardiac-based features 00210-3515-001-06 to obtain the shape, profile, thickness, completeness, cardiac-to-thoracic ratio, etc.; (7) bottom lung boundary processing 00210-3515-001-07; and (8) follow up with calculation of diaphragm based features 00210-3515-001-08 to obtain the profile, curvature, slope, completeness and thickness of the bottom lung;

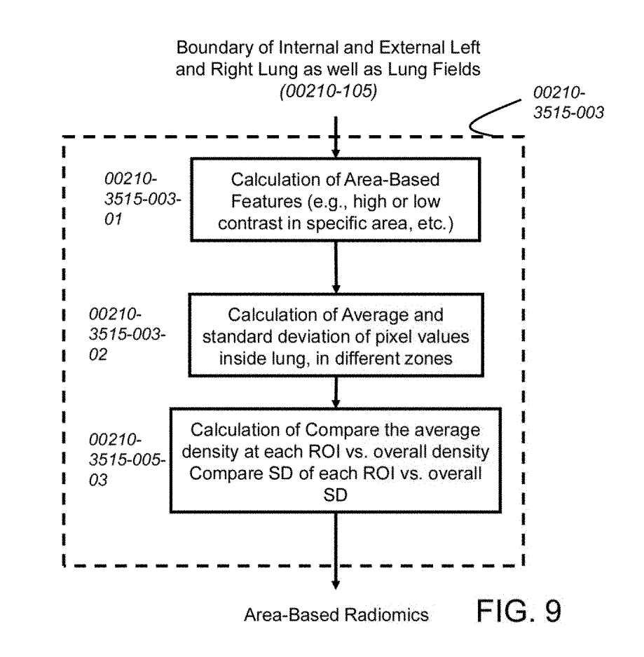

FIG. 9 is a schematic diagram of a radiomics extraction from area-based processing unit 00210-3515-003 according to an embodiment of the present invention;

After receiving boundary of internal and external left and right lungs as well as lung fields 00210-105, radiomics extraction from area-based processing unit 00210-3515-003 consists of (1) calculation of area-based features 00210-3515-003-01 such as high or low contrast in specific area, etc.; (2) calculation of average and standard deviation of pixel values inside lung, in different zones 00210-3515-003-02; and (3) calculation of compare the average density at each region of interest (ROI) with overall density and compare standard deviation (SD) of each ROI with overall SD 00210-3515-003-03. It then generates area-based radiomics.

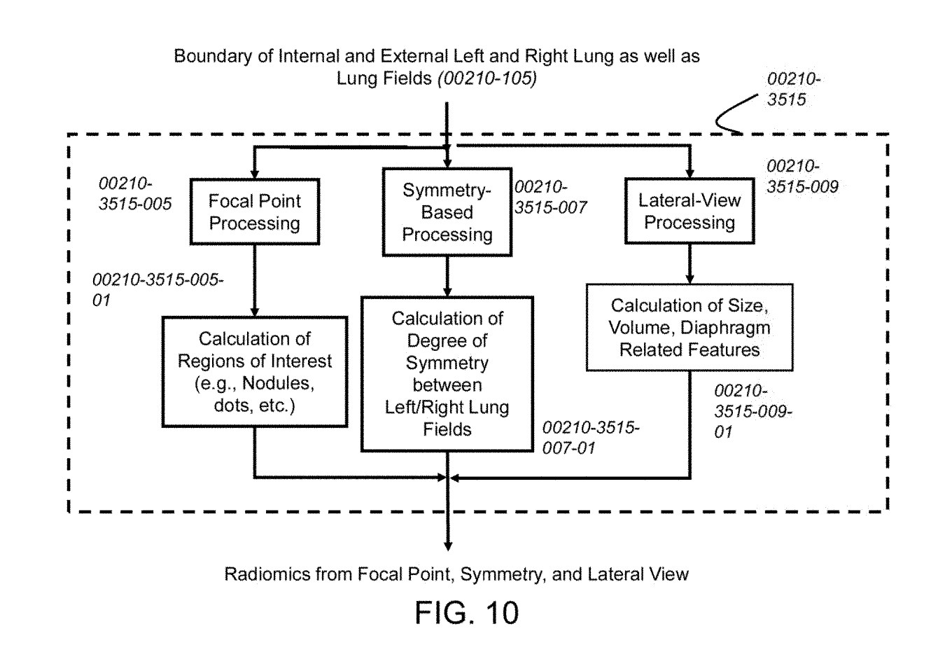

FIG. 10 is a schematic diagram of a radiomics extraction from focal point, symmetry, and lateral view processing unit 00210-3515 according to an embodiment of the present invention.

After receiving boundary of internal and external left and right lungs as well as lung fields 00210-105, a radiomics extraction from focal point, symmetry, and lateral view processing unit 00210-3515 performs extractions using the processing units: (1) focal point processing 00210-3515-005 followed up by calculation of regions of interest 00210-3515-005-01 such as nodules, dots, etc.; (2) symmetry-based processing 00210-3515-007 followed up by calculation of degree of symmetry between left/right lung fields 00210-3515-007-01; and (3) lateral-view processing 00210-3515-009 followed up by calculation of features 00210-3515-009-01 such as size, volume, diaphragm related features.

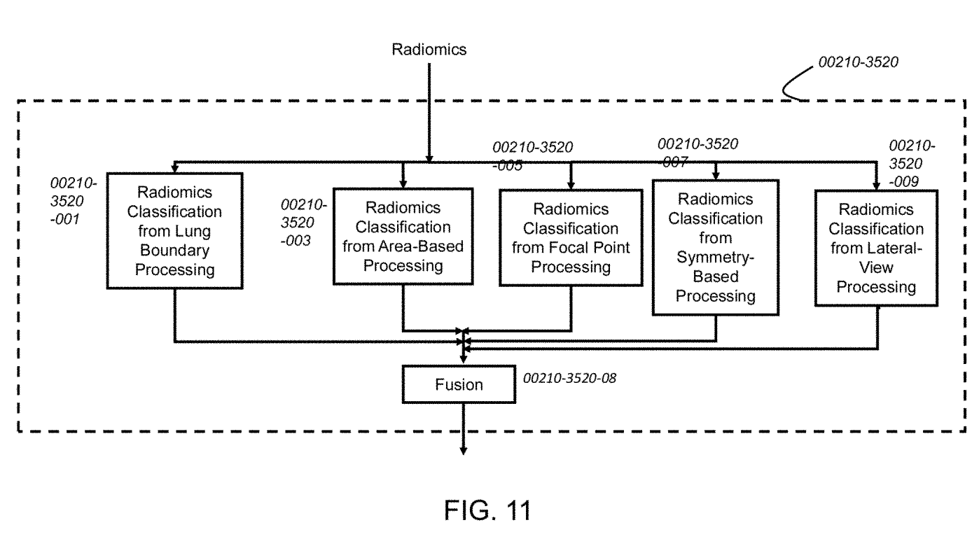

FIG. 11 is a schematic diagram of a classification of radiomics unit 00210-3520 according to an embodiment of the present, invention.

After radiomics is received, the classification of radiomics unit 00210-3520 performs the classification in the radiomics classification from lung boundary processing 00210-3520-001, radiomics classification from area-based processing 00210-3520-003, radiomics classification from focal point processing 00210-3520-005, radiomics classification from symmetry-based processing 00210-3520-007, and radiomics classification from lateral-view processing 00210-3520-009 to feed all of the classification results into fusion processing 00210-3520-008.

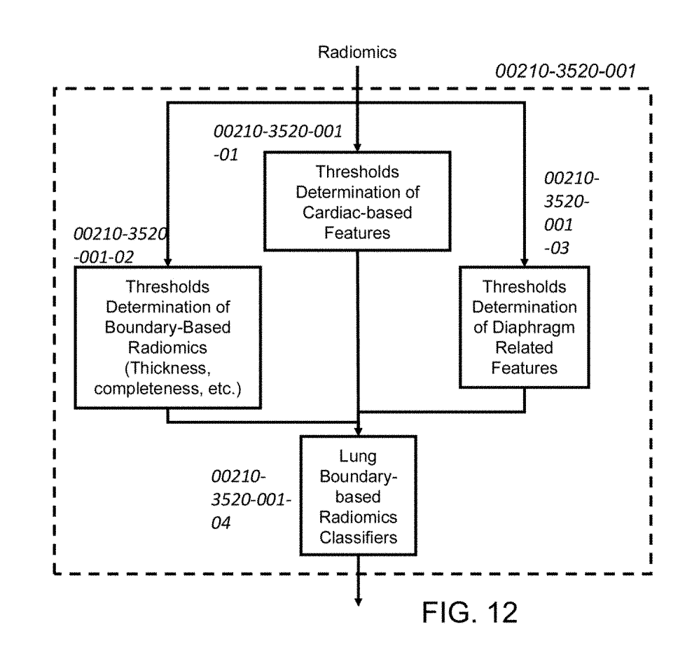

FIG. 12 is a schematic diagram of a radiomics classification from lung boundary processing unit 00210-3520-001 according to an embodiment of the present invention.

Lung boundary processing unit 00210-3520-001 performs the processing in the following components: thresholds determination of cardiac-based features 00210-3520-001-01, thresholds determination of boundary-based radiomics (thickness, completeness, etc.) 00210-3520-001-02, and thresholds determination of diaphragm related features (00210-3520-001-03). These thresholds are sent to lung boundary-based radiomics classifiers 00210-3520-001-04 for classification.

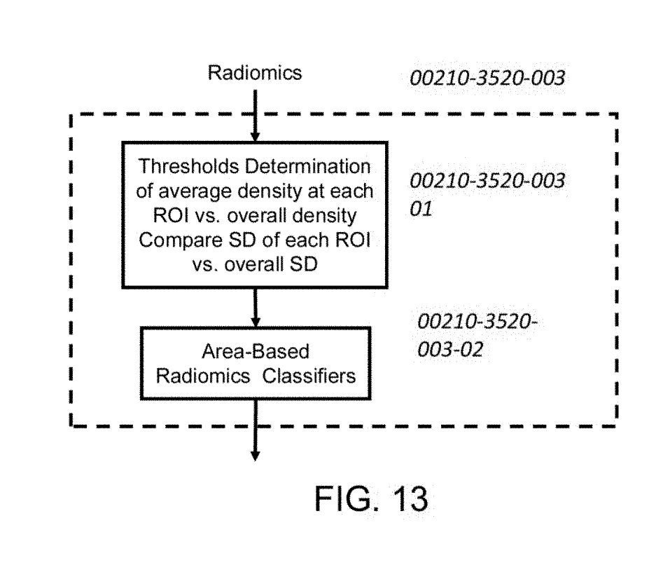

FIG. 13 is a schematic diagram of a radiomics classification from area-based processing unit 00210-3520-003 according to an embodiment of the present invention.

Area-based processing unit 00210-3520-003 receives radiomics to perform processing in thresholds determination of average density at each ROI vs. overall density compare SD of each ROI vs. overall SD 00210-3520-003-01 and area-based radiomics classifiers 00210-3520-003-02.

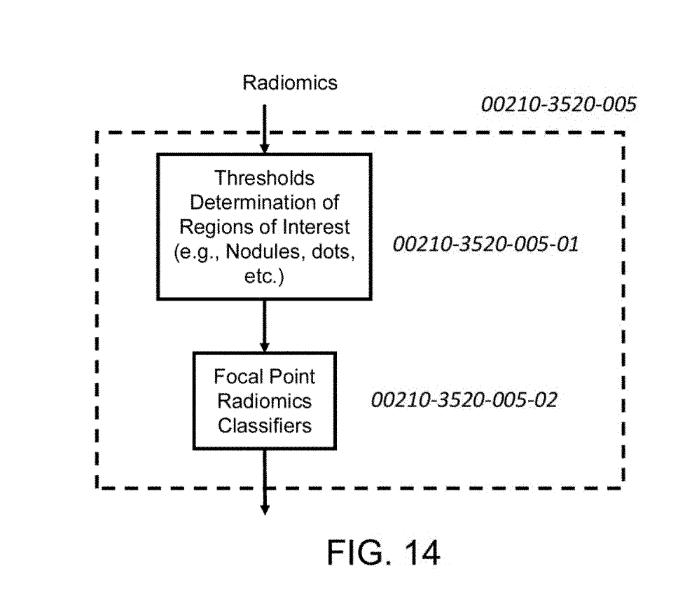

FIG. 14 is a schematic diagram of a radiomics classification from focal Point processing unit 00210-3520-005 according to an embodiment of the present invention.

Focal point processing unit 00210-3520-005 performs the processing in the thresholds determination of regions of interest (e.g., nodules, dots, etc.) 00210-3520-005-1 and focal point classification 00210-3520-005-2.

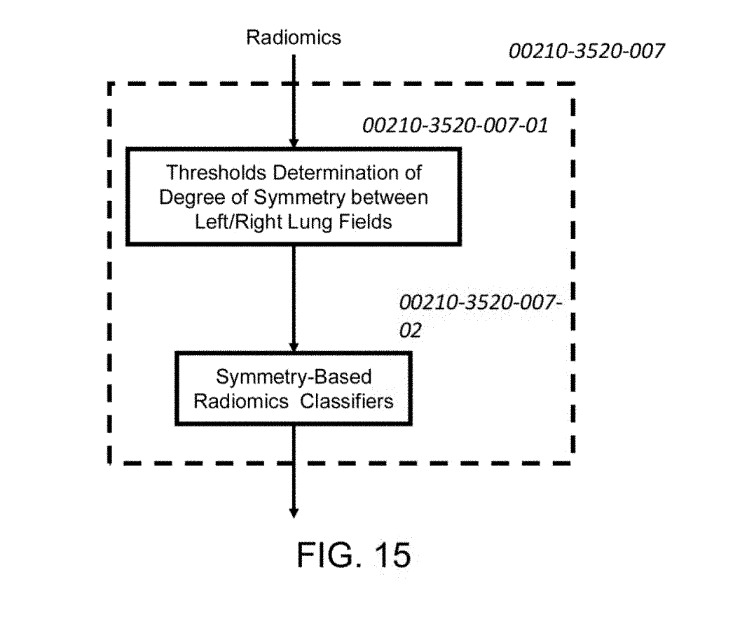

FIG. 15 is a schematic diagram of a radiomics classification from symmetry-based processing unit processing 00210-3520-007 according to an embodiment of the present invention.

Symmetry-based processing unit 00210-3520-007 performs the processing in the thresholds determination of degree of symmetry between left/right lung fields 00210-3520-007-1 and symmetry-based classification 00210-3520-007-2.

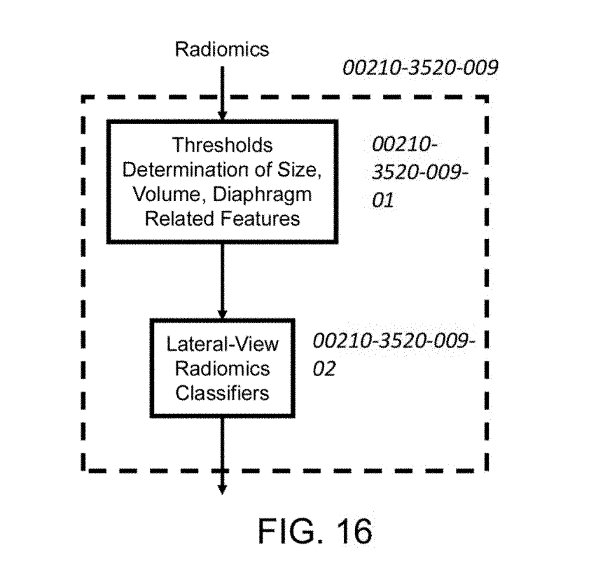

FIG. 16 is a schematic diagram of a radiomics classification from lateral-view processing unit 00210-3520-009 according to an embodiment of the present invention.

Lateral-view processing unit 00210-3520-009 performs the processing in the thresholds determination of size, volume, diaphragm related features 00210-3520-009-1 and lateral-view classification 00210-3520-009-2.

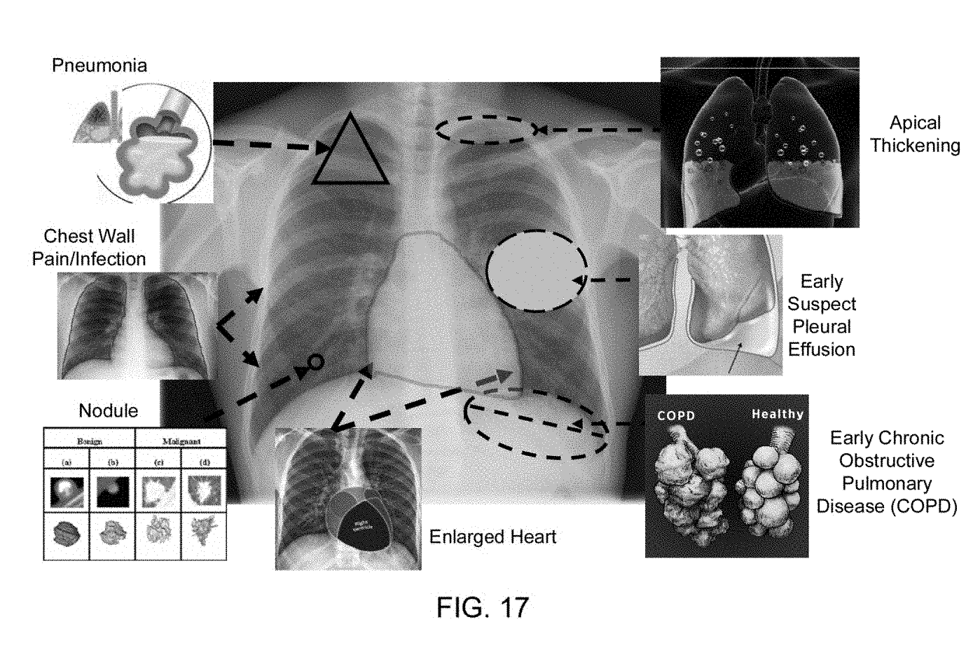

FIG. 17 shows an example of an output from the present invention. The index can include: (1) flat diaphragm—COPD, (2) cardiac-thoracic ratio—heart enlargement, (3) thickness of chest wall, (4) whiteness of lung—pleural effusion, (5) darkness of lung—hyperlucency (signs of COPD), (6) nodules (signs of lung cancer and other diseases), (7) many dots, (8) wedge on apex, of lung, (9) lung volume (need PA and LAT), (10) bronchitis (thinning of bronchi) (sign of COPD), (11) age corrected lung volume: COPD (inspiration effort), (12) aortic atrioventricular septal defect (ASVD), (13) apical thickening, (14) osteopenia, wedge defects, and (15) asbestos exposure resulting in pleural plaques can be associated with a rare cancer mesothelioma.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A method for classifying healthiness indices in a normal radiological image, the method comprising steps of:
image pre-processing comprising image enhancement and normalization processing to enhance image contrast;
image segmentation to identify body parts, and boundaries thereof, the image segmentation step further comprising a sub-step of differentiation of different zones within a lung region of said radiological image based on anatomic structures of the lung region and on local image characteristics;
radiomics extraction to extract radiomics to indicate different image characteristics and features associated with symptom of potential diseases; and
radiomics classification processing based on radiomics to determine the healthiness indices and identify a location of a region of interest.

2. The method according to claim 1, wherein image segmentation step comprises steps of: determination of internal boundary based on image contrast; determination of an external boundary based on the image contrast and a human contour; determination of a boundary between a spine and a lung; determination between a heart and the lung; and division of the lung into a plurality of zones, each of which is further divided into a plurality of several smaller zones.

3. The method according to claim 1, wherein said radiomics extraction step comprises steps of: radiomics extraction by a lung boundary processing unit; radiomics extraction by an area-based processing unit; radiomics extraction by a focal point processing unit; radiomics extraction by a symmetry-based processing unit; and radiomics extraction by a lateral-view processing unit.

4. The method according to claim 3, wherein said radiomics extraction by the lung boundary processing in comprises side lung boundary processing, calculation of boundary-based radiomics, top lung boundary processing, calculation of lung apex features, middle lung boundary processing, calculation of cardiac-based features, bottom lung boundary processing, and calculation of diaphragm related features.

5. The method according to claim 3, wherein said radiomics extraction by the area-based processing unit comprises calculation of area-based features; calculation of average and standard deviation of pixel values inside the lung in different zones; and compare an average density at each region of interest (ROI) with an overall density and compare a standard deviation (SD) of each ROI with an overall SD.

6. The method according to claim 3, wherein said radiomics extraction by the focal point processing unit comprises calculation of regions of interest.

7. The method according to claim 3, wherein said radiomics extraction by the symmetry-based processing unit comprises calculation of a degree of symmetry between left/right lung fields.

8. The method according to claim 3, wherein said radiomics extraction by the lateral view processing unit comprises calculation of size, volume, and diaphragm related features.

9. The method according to claim 3, wherein said healthiness indices comprise a radiomics cardio-thoracic ratio, an age corrected lung volume, aortic atrioventricular septal defect (ASVD), apical thickening, osteopenia, wedge defects, pleural plaques associated with mesothelioma, flat diaphragm, thickness of a chest wall, whiteness of the lung darkness of the lung, a number of nodular and dot patterns, wedges on an apex of the lung, and thinning of a bronchi.

10. The method according to claim 1, wherein said radiomics classification processing step comprises radiomics classification by a lung boundary processing unit, radiomics classification by an area-based processing unit, radiomics classification by a focal point processing unit, radiomics classification by a symmetry-based processing unit, and radiomics classification by a lateral-view processing unit.

11. The method according to claim 10, wherein said radiomics classification by the lung boundary processing unit comprises thresholds determination of cardiac-based features, thresholds determination of boundary-based radiomics, thresholds determination of diaphragm related features, and lung boundary-based radiomics classifiers.

12. The method according to claim 10, wherein said radiomics classification by the area-based processing unit comprises thresholds determination of an average density at each region of interest (ROI) by comparing to an overall standard deviation (SD) and area-based radiomics classifiers.

13. The method according to claim 10, wherein said radiomics classification by the focal point processing unit comprises thresholds determination of regions of interest and focal point radiomics classifiers.

14. The method according to claim 10, wherein said radiomics classification by the symmetry-based processing unit comprises thresholds determination of a degree of symmetry between left/right lung fields, and symmetry-based radiomics classifiers.

15. The method according to claim 10, wherein said radiomics classification by the lateral-view processing unit comprises thresholds determination of size, volume, and diaphragm related features and lateral-view-based radiomics classifiers.

16. The method according to claim 1, said image segmentation step comprises a step of: discarding image pixels that correspond to regions outside a chest in said radiological image.

17. The method according to claim 16, wherein said different zones comprise clavicle, peripheral edge, spine, heart, and mediastinum.

18. The method according to claim 1, wherein said radiomics classification processing step comprises determining different healthiness indices indicating a degree of healthiness.

19. The method according to claim 18, wherein said healthiness indices comprises different quantification levels.

20. The method according to claim 1, said radiomics classification processing step comprises steps of: using a different classifier for each said zones; and combining radiomics based on performances of the different classifiers for the zones.

21. A method, to be used in a non-diagnostic medical cloud computing environment, for performing computer-aided-analysis (CAA) capability in said cloud computing environment, said method comprising steps of:
transmitting image data from at least one non-diagnostic-medical imaging acquisition system or individual computers, smartphones, or storage devices to at least one computer-aided-analysis (CAA) system in the cloud computing environment and at least one archive/review station;
generating computer-aided-analysis results by processing said image data to determine radiomics and classify into a plurality of healthiness indices in the image data using said CAA system, while archiving and viewing said image data on at least said at least one of archive/review station, the computers, the smartphones, printed media, and the storage devices; and
transmitting said computer-aided-analysis results from said CAA system via an Internet by cloud computing to at least said at least one of archive/review station, the computers, the smartphones, the printed media, and the storage devices,
wherein said transmitting image data step and said transmitting said computer-aided-analysis results are performed in a digital imaging and communications in medicine (DICOM) image formats and over the Internet connected among said at least one non-diagnostic medical imaging acquisition system, said CAA system, and said at least one archive/review station, the computers, the smartphones, the printed media, or the storage devices.
